(19) United States
(12) Patent Application Publication
(10) Pub. No.: US 2021/0368523 A1
(43) Pub. Date: Nov. 25, 2021

(54) USER TERMINAL AND RADIO COMMUNICATION METHOD

(71) Applicant: NTT DOCOMO, INC., Tokyo (JP)

(72) Inventors: Shohei Yoshioka, Tokyo (JP); Kazuki Takeda, Tokyo (JP); Satoshi Nagata, Tokyo (JP); Runxin Wang, Beijing (CN)

(73) Assignee: NTT DOCOMO, INC., Tokyo (JP)

(21) Appl. No.: 16/976,949

(22) PCT Filed: Feb. 27, 2019
(86) PCT No.: PCT/JP2019/007634

§ 371 Date: Aug. 31, 2020

(30) Foreign Application Priority Data
Mar. 1, 2018 (JP) 2018-051666

(51) Int. Cl. H04W 72/12; H04W 72/04

(52) U.S. Cl. CPC H04W 72/1263; H04W 72/0453; H04W 72/0446; H04W 72/1257

(57) ABSTRACT

The present invention is designed so that the transport block size will be determined properly in future radio communication systems. According to one aspect of the present disclosure, a user terminal has a transmitting/receiving section that performs at least one of receipt and transmission of a transport block (TB) by using a data channel in a predetermined period, and a control section that calculates a total number of resource elements allocated to the data channel in the above predetermined period, by taking into account another channel that is allocated in the predetermined period.

### TECHNICAL FIELD

The present disclosure relates to a user terminal and a radio communication method in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower latency and so on (see non-patent literature 1). Successor systems of LTE (referred to as, for example, “LTE-A (LTE-Advanced),” “FRA (Future Radio Access),” “4G,” “5G,” “5G+(plus),” “NR (New RAT),” “LTE Rel. 14,” “LTE Rel. 15 (or later versions),” etc.) are also under study for the purpose of achieving further broadbandization and increased speed beyond LTE.

In existing LTE systems (for example, LTE Rel. 8 to 13), a user terminal (UE (User Equipment)) controls the receipt of a downlink shared channel (for example, PDSCH (Physical Downlink Shared CHannel)) based on downlink control information (also referred to as “DCI,” “DL assignment,” etc.) from a radio base station. Furthermore, a user terminal controls the transmission of an uplink shared channel (for example, PUSCH (Physical Uplink Shared CHannel)) based on DCI (also referred to as “UL grant,” etc.).

Also, in existing LTE systems, a TBS table, in which transport block sizes (TBSs) for each number of resource blocks (PRB (Physical Resource Blocks)) (the number of PRBs) and TBS indices are associated, is set forth in advance. A user terminal determines the TBS using this TBS table.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (for example, LTE Rel. 15 or later versions, 5G, NR, etc.), research is underway to allow a user terminal to determine the TBS without the TBS table used in existing LTE systems (for example, LTE Rel. 8 to 13).

Also, a case where other channels (for example, a physical downlink control channel (PDCCH)) are allocated in part or all of the RBs that are allocated for a PDSCH, may be possible. If equations that have been under study up till then in relationship to NR are used in such a case, the number of REs (N_{RE}) may not be calculated properly, and the wrong TBS may be selected. As a result of this, a decline in throughput might occur.

So, the present inventors have come up with the idea of calculating the number of REs (N_{RE}) to use to determine the TBS by taking into account the allocation of channels other than data channels.

It is therefore an object of the present disclosure to provide a user terminal and a radio communication method, whereby the transport block size can be determined properly in future radio communication systems.

### Solution to Problem

One aspect of the present disclosure provides a user terminal, which has a transmitting/receiving section that performs at least one of receipt and transmission of a transport block (TB) by using a data channel in a predetermined period, and a control section that calculates a total number of resource elements allocated to the data channel in the above predetermined period, by taking into account another channel that is allocated in the predetermined period.

### Advantageous Effects of Invention

According to the present disclosure, the transport block size can be determined properly in future radio communication systems.

### BRIEF DESCRIPTION OF DRAWINGS

FIG. 1A is a diagram to show an example of an MCS table in existing LTE systems, and FIG. 1B is a diagram to show an example of a TBS table in existing LTE systems;

FIG. 2A is a diagram to show an example of an MCS table in future radio communication systems, and FIG. 2B is a diagram to show an example of a quantization table in future radio communication systems;

FIG. 3 is a diagram to show an example in which a PDCCH is allocated in part of RBs that are allocated for a PDSCH;

FIG. 4 is a diagram to show an example of parameters for use for calculating the total number of REs allocated to a PDSCH, according to the present embodiment;

FIG. 5 is a diagram to show an exemplary schematic structure of a radio communication system according to the present embodiment;

FIG. 6 is a diagram to show an exemplary overall structure of a radio base station according to the present embodiment;

FIG. 7 is a diagram to show an exemplary functional structure of a radio base station according to the present embodiment;

FIG. 8 is a diagram to show an exemplary overall structure of a user terminal according to the present embodiment;

FIG. 9 is a diagram to show an exemplary functional structure of a user terminal according to the present embodiment; and

FIG. 10 is a diagram to show an exemplary hardware structure of a radio base station and a user terminal according to the present embodiment.

### DESCRIPTION OF EMBODIMENTS

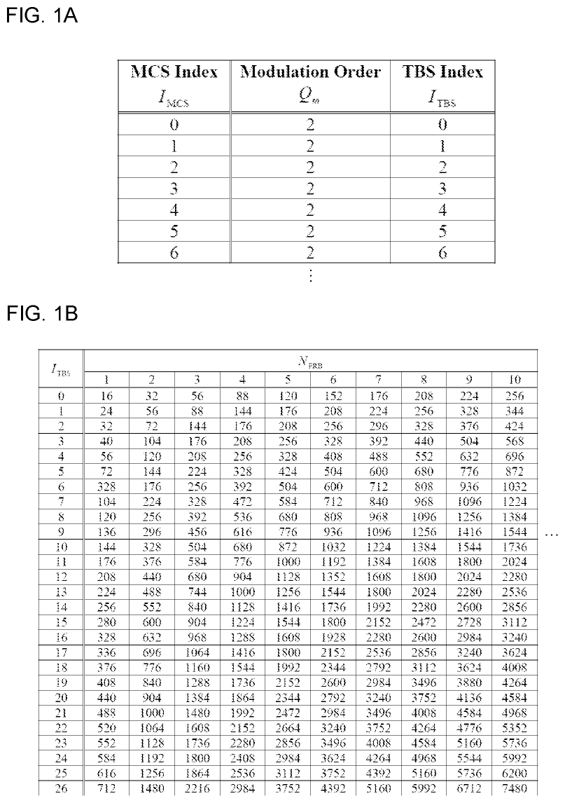

FIG. 1 provide diagrams to show examples of an MCS table (FIG. 1A) and a TBS table (FIG. 1B) in existing LTE systems (for example, LTE Rel. 8 to 13). As shown in FIG. 1A, in existing LTE systems, an MCS table, in which modulation coding scheme (MCS) indices, modulation orders and TBS indices are associated, is set forth (stored in a user terminal).

Also, as shown in FIG. 1B, in existing LTE systems, a TBS table that associates a TBS index (I_{TBS}) and a TBS for each number of PRBs (N_{PRB}) is defined (stored in a user terminal).

In existing LTE systems, the user terminal receives DCI (DL assignment) for scheduling PDSCH, and selects the TBS index that corresponds to the MCS index included in this DCI, with reference to the MCS table (FIG. 1A). Also, the user terminal selects the TBS that is associated with the TBS index and the number of PRBs allocated to the PDSCH, for the PDSCH, with reference to the TBS table (FIG. 1B).

Similarly, in existing LTE systems, the user terminal receives DCI (DL grant) for scheduling PDSCH, and selects the TBS index that corresponds to the MCS index included in this DCI, with reference to the MCS table (FIG. 1A). Also, the user terminal selects the TBS that is associated with the TBS index and the number of PRBs allocated to the PUSCH, for the PUSCH, with reference to the TBS table (FIG. 1B).

Envisaging future radio communication systems (for example, LTE Rel. 15 or later versions, 5G, 5G+, NR, etc.), research is underway to allow a user terminal to determine the TBS without the TBS table used in existing LTE systems (for example, LTE Rel. 8 to 13).

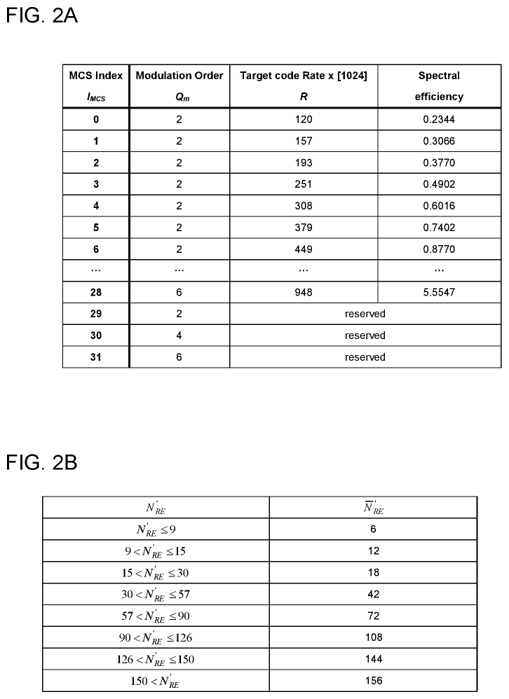

FIG. 2 are diagrams to show examples of the MCS table (FIG. 2A) and a table for quantizing the number of resource elements (REs) per PRB (FIG. 2B), for future existing LTE systems. Note that FIGS. 2A and 2B are simply examples, and the values shown in these drawings are by no means limiting, and part of the items (fields) may be deleted, or items that are not shown may be added.

As shown in FIG. 2A, in future radio communication systems, an MCS table to associate modulation orders, code rates (which may be an expected code rate, also referred to as a “target code rate”), and indices that indicate these modulation orders and code rates (for example, MCS indices), may be set forth (may be stored in a user terminal). Note that, in the MCS table, spectral efficiency may be associated in addition to the above three items.

Also, as shown in FIG. 2B, in future radio communication systems, a table (quantization table) to show the quantized number of REs allocated to at least one of PDSCH and PUSCH in one PRB may be set forth (may be stored in a user terminal).

In future radio communication systems, a user terminal determines the TBS using at least one of the following steps (1) to (4). The TBS is preferably determined so that the target code rate is kept as intended.

Note that the following steps (1) to (4) will be described as an example of determining the TBS for PDSCH, but the following steps (1) to (4) can be suitably applied to an example of determining the TBS for PUSCH by replacing “PDSCH” with “PUSCH.”

Step (1)

The user terminal first determines the number of REs (N_{RE}) in a slot. To be more specific, the user terminal may determine the number of REs (N′_{RE}) allocated to PDSCH in one PRB, for example, by using following equation 1:

N′_{RE}=N_{sc}^{RB}*N_{symb}^{sh}−N_{DMRS}^{PRB}−Nₒₕ^{PRB} (Equation 1)

Here, N^{RB}_{sc} is the number of subcarriers per RB, and may be N^{RB}_{sc}=12, for example. N^{sh}_{symb} is the number of symbols (for example, OFDM symbol) scheduled in a slot. Note that, in the present specification, a “slot” may be replaced with other units of time, and may be replaced by a “minislot,” a “subframe,” a “symbol” and so forth.

N^{PRB}_{DMRS} is the number of REs for DMRS per PRB, within a scheduled period (for example, a slot). The number of REs for DMRS may include the overhead of a group with respect to code division multiplexing (CDM) of the DMRS indicated by DCI.

N^{PRB}ₒₕ may be a value configured by a higher layer parameter. For example, N^{PRB}ₒₕ may be overhead indicated by a higher layer parameter (Xoh-PDSCH), or may be one of the values 0, 6, 12 and 18.

The user terminal quantizes the number of REs (N′_{RE}) allocated to PDSCH in one PRB, with reference to a quantization table (see, for example, FIG. 2B). For example, when the number of REs (N′_{RE}) determined by using above equation 1 is nine or less, according to the quantization table shown in FIG. 2B, the quantized number (N̅′̅_{RE}) of REs allocated to PDSCH in one PRB is six.

The user terminal determines the total number of REs (N_{RE}) allocated to the PDSCH based on the quantized number of REs (N̅′̅_{RE}) allocated to PDSCH in one PRB above and the total number of PRBs (n_{PRB}) allocated to the user terminal (see, for example, equation 2).

N_{RE}=N̅′_{RE}*n_{PRB} (Equation 2)

Step (2)

The user terminal determines the intermediate number of information bits (N_{info}), by using, for example, equation 3:

N_{info}=N_{RE}*R*Qₘ*v (Equation 3)

Here, N_{RE} is the total number of REs allocated to the PDSCH. R is the code rate that is associated with the MCS index included in DCI in the MCS table (for example, FIG. 2A). Qₘ is the modulation order that is associated with the MCS index included in this DCI in the MCS table. v is the number of PDSCH layers.

Step (3)

When the intermediate number of information bits (N_{info}) determined in step (2) is equal to or lower than (or less than) a predetermined threshold (for example, 3824), the user terminal may quantize the intermediate number, and find the TBS that is equal to or greater than (not less than) the quantized intermediate number (N′info) and that is the closest, from a predetermined table (for example, a table that associates TBSs and indices).

Step (4)

On the other hand, when the intermediate number of information bits (N_{info}) determined in step (2) is larger than (or not less than) a predetermined threshold (for example, 3824), the user terminal may quantize the intermediate number (N_{info}), for example, by using equation 4, and determine the quantized intermediate number (N′info).

$${{N}^{′}}_{info} = {2}^{n} \times round ( \frac{{N}_{info} - 24}{{2}^{n}} ) where n = ⌊ {log}_{2} ( {N}_{info} - 24 ) ⌋ - 5 \qquad ( Equation 4 )$$

Here, in the above MCS table (for example, FIG. 2A), when the code rate (R) that is associated with the MCS index in DCI is equal to or lower than (or less than) a predetermined threshold (for example, 1/4), the user terminal may determine the TBS by using, for example, following equation 5. Here, N′info is the intermediate number quantized by using, for example, above equation 4. Also, C may be the number of code blocks (CBs) into which a TB is divided.

$$T B S = 8 * C * ⌈ \frac{{{N}^{′}}_{info} + 24}{8 * C} ⌉ - 24 , where C = ⌈ \frac{{{N}^{′}}_{info} + 24}{3816} ⌉ \qquad ( Equation 5 )$$

On the other hand, when the above code rate (R) is greater than (or not less than) a predetermined threshold (for example, 1/4) and the quantized intermediate number of information bits (N′info) is greater than (or not less than) a predetermined threshold (for example, 8424), the user terminal may determine the TBS by using, for example, following equation 6:

$$TBS = 8 * C * ⌈ \frac{{{N}^{′}}_{info} + 24}{8 * C} ⌉ - 24 , where C = ⌈ \frac{{{N}^{′}}_{info} + 24}{8424} ⌉ \qquad ( Equation 6 )$$

Also, when the above code rate (R) is equal to or less than (or less than) a predetermined threshold (for example, 1/4) and the quantized intermediate number (N′info) is equal to or less than (or less than) a predetermined threshold (for example, 8424), the user terminal may determine the TBS by using, for example, following equation 7:

$$T B S = 8 * ⌈ \frac{{{N}^{′}}_{info} + 24}{8} ⌉ - 24 \qquad ( Equation 7 )$$

In this way, envisaging future radio communication systems, studies are underway to allow a user terminal to determine the intermediate number of information bits (N_{info}) based on at least one of the number of REs (N_{RE}) that can be used for a PDSCH or a PUSCH in a slot, the code rate (R), the modulation order (Qm), and the number of layers, and determines the TBS for the PDSCH or the PUSCH based on the quantized intermediate number (N′info) obtained by quantizing the intermediate number (N_{info}). In particular, in future radio communication systems, it is assumed that a user terminal will calculate the TBS without using a table in which the TBS is set forth in advance.

Now, when calculating the number of REs (N_{RE}) in a slot in above step (1), channels other than data channels (for example, PDSCH) (for example, a downlink control channel (PDCCH (Physical Downlink Control CHannel))) are not taken into account. For example, equation 1 and equation 2 in step (1) do not include terms related to PDCCH.

That is, in above step (1), it is assumed that each RB for the PDSCH is formed by same OFDM symbols (the same number of OFDM symbols). For example, it is assumed that the RBs scheduled for the PDSCH do not include PDCCH.

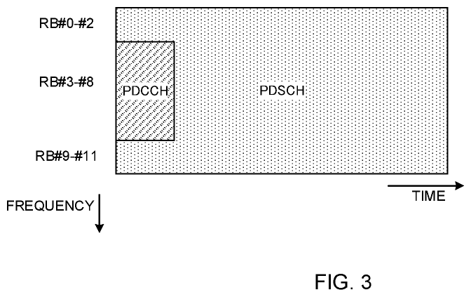

However, a case where other channels (for example, PDCCH) are allocated in part or all of the RBs that are allocated for a PDSCH, may be possible. FIG. 3 is a diagram to show an example in which a PDCCH is allocated in part of RBs that are allocated for a PDSCH. In the example of FIG. 3, the PDCCH is allocated in part of symbols in RBs #3 to #8, which are part of RBs #0 to #11 allocated for the PDSCH.

If equation 1 and equation 2 are used in the case shown in FIG. 3, the number of REs (N_{RE}) may not be calculated properly, and the wrong TBS may be selected. As a result of this, a decline in throughput might occur.

So, the present inventors have come up with the idea of calculating the number of REs (N_{RE}) to use to determine the TBS by taking into account the allocation of channels other than data channels.

Now, embodiments of the present invention will be described below in detail. Note that the herein-contained embodiments can be used to determine at least one of the TBS for PDSCH and the TBS for PUSCH.

Furthermore, in the following description, examples will be shown in which the number of REs (N_{RE}) to use to determine the TBS is calculated by taking into account the allocation of PDCCH, but this is by no means limiting. A PDCCH may be interpreted as one or more channels (including, for example, PDCCH, an uplink control channel (PUCCH (Physical Uplink Control CHannel)), etc.).

(Radio Communication Method)

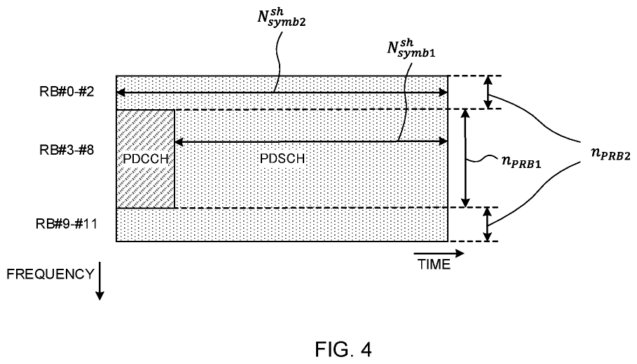

FIG. 4 is a diagram to show an example of parameters for use for calculating the total number of REs allocated to a PDSCH, according to the present embodiment. The resources allocated to the PDCCH and the PDSCH in this example are the same as in the example of FIG. 3.

Here, N^{sh}_{symb1} is the number of symbols (for example, OFDM symbols) scheduled in RBs including the PDCCH (to be more specific, including the PDCCH and the PDSCH). Here, N^{sh}_{symb2} is the number of symbols (for example, OFDM symbols) scheduled in RBs not including the PDCCH (to be more specific, including the PDSCH).

Also, n_{PRB1} is the total number of RBs including the PDCCH (to be more specific, including the PDCCH and the PDSCH). Also, n_{PRB2} is the total number of RBs not including the PDCCH (to be more specific, including the PDSCH).

In this example, n_{PRB1}=6 and n_{PRB2}=6 hold. Note that the RBs including the PDCCH and/or the RBs not including the PDCCH may be contiguous or non-contiguous in the frequency domain. For example, the RBs to include the PDCCH in FIG. 3 are contiguous in the frequency domain, while the RBs not including the PDCCH in FIG. 3 are non-contiguous in the frequency domain.

Hereinafter, some examples will be described with reference to FIG. 4.

### First Example

With a first example of the present invention, a user terminal calculates the total number of REs (N_{RE}) allocated to a PDSCH based on the number of REs (N′_{RE1}) allocated to the PDSCH in one PRB where a PDCCH is included, and the number of REs (N′_{RE2}) allocated to the PDSCH in one PRB where no PDCCH is included.

N′_{RE1} and N′_{RE2} may be obtained by using following equation 8 and equation 9, respectively.

N′_{RE1}=N_{sc}^{RB}*N_{symb1}^{sh}−N_{DMRS}^{PRB}−Nₒₕ^{PRB} (Equation 8)

N′_{RE2}=N_{RB}*N_{symb2}^{sh}−N_{DMRS}^{PRB}−Nₒₕ^{PRB} (Equation 9)

Each parameter has already been described, and therefore will not be described again.

The user terminal quantizes N′_{RE1} and N′_{RE2} into (N̅′̅_{RE1}) and (N̅′̅_{RE2}), respectively, using a quantization table (for example, that shown in FIG. 2B). Note that the same quantization table may be used, or different quantization tables may be used, for the quantization to (N̅′̅_{RE1}) and the quantization to (N̅′̅_{RE2}).

The user terminal determines the total number of REs (N_{RE1}) allocated to the PDSCH in all the PRBs where the PDCCH is included, based on the quantized number of REs (N̅′̅_{RE1}), allocated to the PDSCH in one PRB where the PDCCH is included, and the total number of PRBs (n_{PRB1}) where the PDCCH allocated to the user terminal is included (by using, for example, following equation 10).

Also, the user terminal determines the total number of REs (N_{RE2}) allocated to the PDSCH in all the PRBs where the PDCCH is not included, based on the quantized number of REs (N̅′̅_{RE2}), allocated to the PDSCH in one PRB where the PDCCH is not included, and the total number of PRBs (n_{PRB2}) where the PDCCH allocated to the user terminal is not included (by using, for example, following equation 11).

N_{RE1}=N̅′_{RE1}*n_{PRB1} (Equation 10)

N_{RE2}=N̅′_{RE2}*n_{PRB2} (Equation 11)

The user terminal calculates the total number of REs (N_{RE}) allocated to the PDSCH based on N_{RE1} and N_{RE2} (by using, for example, following equation 12).

N_{RE}=N_{RE1}+N_{RE2}=N̅′_{RE1}*n_{PRB1}+N̅′_{RE2}*n_{PRB2} (Equation 12)

### Second Example

With a second example of the present invention, a user terminal calculates the average number of symbols (N̅^{sh}_{symb}) to be scheduled for a PDSCH based on the number of symbols scheduled in RBs where a PDCCH is included (N^{sh}_{symb1}), and the number of symbols scheduled in RBs where no PDCCH is included (N^{sh}_{symb2}). Then, the user terminal calculates the total number of REs (N_{RE}) allocated to the PDSCH, based on the average number of symbols.

The user terminal calculates the average number of symbols (N̅^{sh}_{symb}) scheduled for the PDSCH, by using, for example, following equation 13.

N̅^{sh}_{symb}=(N^{sh}_{symb1}*n_{PRB1}+N^{sh}_{symb2}*n_{PRB2})/(n_{PRB1}n_{PRB2}) (Equation 13)

Each parameter has already been described, and therefore will not be described again.

The user terminal may determine the number of REs (N′RE) allocated to PDSCH in one PRB based on the average number of symbols (N̅^{sh}_{symb}) scheduled for the PDSCH (by using, for example, following equation 14).

N′_{RE}=N_{sc}^{RB}*N^{sh}_{symb}−N_{DMRS}^{PRB}−Nₒₕ^{PRB} (Equation 14)

As described above, the user terminal may quantize N′_{RE} into (N̅′̅_{RE}) by using a quantization table (for example, that of FIG. 2B). Also, the user terminal may determine the total number of REs (N_{RE}) allocated to the PDSCH based on (N̅′̅_{RE}) and the total number of PRBs (n_{PRB}=n_{PRB1}+n_{PRB2}) allocated to the user terminal (by using, for example, equation 2 above).

### Third Example

With a third example of the present invention, a user terminal calculates the total number of REs (N_{RE}) allocated to a PDSCH, by the same method as in step (1) described above. However, in the third example, N^{PRB}ₒₕ is determined by taking into account the PDCCH.

For example, the base station may determine N^{PRB}ₒₕ based on at least one of the value of N^{PRB}ₒₕ that is associated with one PRB where no PDCCH is included (for example, N^{PRB}_{oh_PDSCH}), N^{sh}_{symb1}, N^{sh}_{symb2}, n_{PRB1} and n_{PRB2}, and configure this in the user terminal.

According to each example described above, for example, the number of REs for the PDSCH can be accurately calculated by taking into account the PDCCH, so that better throughput performance can be achieved for desired target code rates.

<Variations>

The equations presented herein may be replaced with equations including other parameters that are not shown, or may be modified as appropriate.

For example, equation 14 may be changed to equation 15, which includes N^{PRB}_{UCI}.

N′_{RE}=N_{sc}^{RB}*N^{sh}_{symb}−N_{DMRS}^{PRB}−Nₒₕ^{PRB}−N_{UCI}^{PRB} (Equation 15)

Here, N^{PRB}_{UCI} is the number of REs for uplink control information (UCI) per PRB within a scheduled period (for example, a slot). For example, when UCI including at least one of delivery acknowledgment information (which may be referred to as “HARQ-ACK,” “ACK/NACK,” etc.), a scheduling request (SR), channel state information (CSI) and so on, is transmitted in the slot where a PDSCH is scheduled, equation 15 can be used.

(Radio Communication System)

Now, the structure of a radio communication system according to the present embodiment will be described below. In this radio communication system, the radio communication methods according to the above-described embodiments are employed. Note that the radio communication methods according to the herein-contained embodiments may be each used alone, or at least two of them may be combined and used.

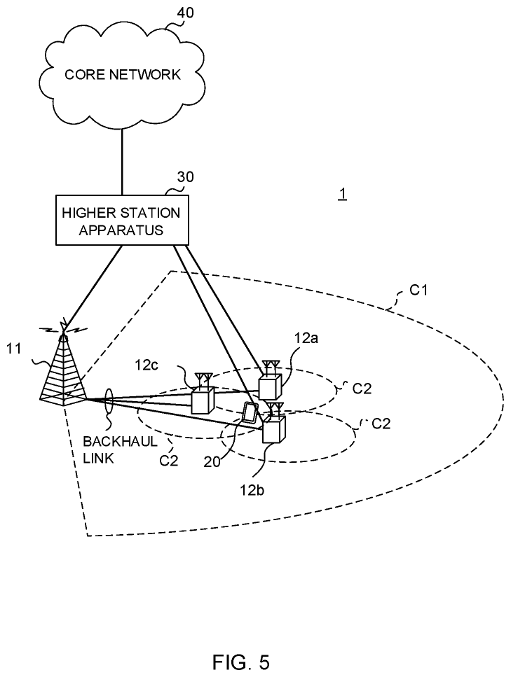

FIG. 5 is a diagram to show an exemplary schematic structure of a radio communication system according to the present embodiment. A radio communication system 1 can adopt carrier aggregation (CA) and/or dual connectivity (DC) to group a number of fundamental frequency blocks (component carriers) into one, where the LTE system bandwidth (for example, 20 MHz) constitutes one unit. Note that the radio communication system 1 may be referred to as “SUPER 3G,” “LTE-A, (LTE-Advanced)” “IMT-Advanced,” “4G,” “5G,” “FRA (Future Radio Access),” “NR (New RAT (New Radio Access Technology)),” and the like.

The radio communication system 1 shown in FIG. 5 includes a radio base station 11 that forms a macro cell C1, and radio base stations 12a to 12c that are placed within the macro cell C1 and that form small cells C2, which are narrower than the macro cell C1. Also, user terminals 20 are placed in the macro cell C1 and in each small cell C2. A structure in which different numerologies are applied between cells/within cells may be adopted here.

Here, a numerology refers to a communication parameter in the frequency direction and/or the time direction (for example, at least one of subcarrier spacing, the bandwidth, the length of a symbol, the length of CP (CP length), the length of a subframe, the time length of a TTI (TTI length), the number of symbols per TTI, the radio frame configuration, the filtering process, the windowing process, etc.). In the radio communication system 1, for example, subcarrier spacings such as 15 kHz, 30 kHz, 60 kHz, 120 kHz and 240 kHz may be supported.

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can execute CA or DC by using a number of cells (CCs) (for example, two or more CCs). Furthermore, the user terminals can use licensed-band CCs and unlicensed-band CCs as a number of cells.

Furthermore, the user terminals 20 can communicate based on time division duplexing (TDD) or frequency division duplexing (FDD) in each cell. A TDD cell and an FDD cell may be referred to as a “TDD carrier (frame structure type 2)” and an “FDD carrier (frame structure type 1),” respectively.

Furthermore, in each cell (carrier), a single numerology may be used, or a number of different numerologies may be used.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier,” and/or the like). Meanwhile, between the user terminals 20 and the radio base stations 12, a carrier of a relatively high frequency band (for example, 3.5 GHz, 5 GHz, 30 to 70 GHz and so on) and a wide bandwidth may be used, or the same carrier as that used in the radio base station 11 may be used. Note that the structure of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “gNB (gNodeB),” a “transmitting/receiving point (TRP),” and so on. Also, the radio base stations 12 are radio base stations each having a local coverage, and may be referred to as “small base stations,” “micro base stations,” “pico base stations,” “femto base stations,” “HeNBs (Home eNodeBs),” “RRHs (Remote Radio Heads),” “eNBs,” “gNBs,” “transmitting/receiving points” and so on. Hereinafter, the radio base stations 11 and 12 will be collectively referred to as “radio base stations 10,” unless specified otherwise.

The user terminals 20 are terminals to support various communication schemes such as LTE, LTE-A, 5G, 5G+, NR, Rel.15 and later versions, and so on, and may be either mobile communication terminals or stationary communication terminals. Furthermore, the user terminals 20 can perform device-to-device (D2D) communication with other user terminals 20.

In the radio communication system 1, as radio access schemes, OFDMA (orthogonal Frequency Division Multiple Access) can be applied to the downlink (DL), and SC-FDMA (Single-Carrier Frequency Division Multiple Access) can be applied to the uplink (UL). OFDMA is a multi-carrier communication scheme to perform communication by dividing a frequency bandwidth into a number of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a number of terminals to use mutually different bands. Note that the uplink and downlink radio access schemes are not limited to the combination of these, and OFDMA may be used in the UL.

Also, in the radio communication system 1, a multi-carrier waveform (for example, OFDM waveform) or a single-carrier waveform (for example, DFT-s-OFDM waveform) may be used.

In the radio communication system 1, a DL shared channel (PDSCH (Physical Downlink Shared CHannel), also referred to as a “downlink data channel” or the like), which is shared by each user terminal 20, a broadcast channel (PBCH (Physical Broadcast CHannel)), L1/L2 control channels and so on are used as downlink (DL) channels. At least one of user data, higher layer control information, SIBs (System Information Blocks) and so forth is communicated by the PDSCH. Also, the MIB (Master Information Blocks) is communicated by the PBCH.

The L1/L2 control channels include downlink control channels (such as PDCCH (Physical Downlink Control CHannel), EPDCCH (Enhanced Physical Downlink Control CHannel), etc.), PCFICH (Physical Control Format Indicator CHannel), PHICH (Physical Hybrid-ARQ Indicator CHannel) and so on.

Downlink control information (DCI), including PDSCH and PUSCH scheduling information, is communicated by the PDCCH. The number of OFDM symbols to use for the PDCCH is communicated by the PCFICH. The EPDCCH is frequency-division-multiplexed with the PDSCH and used to communicate DCI and so on, like the PDCCH. HARQ delivery acknowledgment information (ACK/NACK) in response to the PUSCH can be communicated in at least one of the PHICH, the PDCCH and the EPDCCH.

In the radio communication system 1, an uplink shared channel (PUSCH (Physical Uplink Shared CHannel), also referred to as an “uplink data channel” or the like), which is shared by each user terminal 20, an uplink control channel (PUCCH (Physical Uplink Control CHannel)), a random access channel (PRACH (Physical Random Access CHannel)) and so on are used as uplink (UL) channels. User data, higher layer control information and so on are communicated by the PUSCH. Uplink control information (UCI), including at least one of delivery acknowledgment information (A/N) in response to downlink (DL) signals, channel state information (CSI) and so on is communicated by the PUSCH or the PUCCH.

By means of the PRACH, random access preambles for establishing connections with cells can be communicated.

<Radio Base Station>

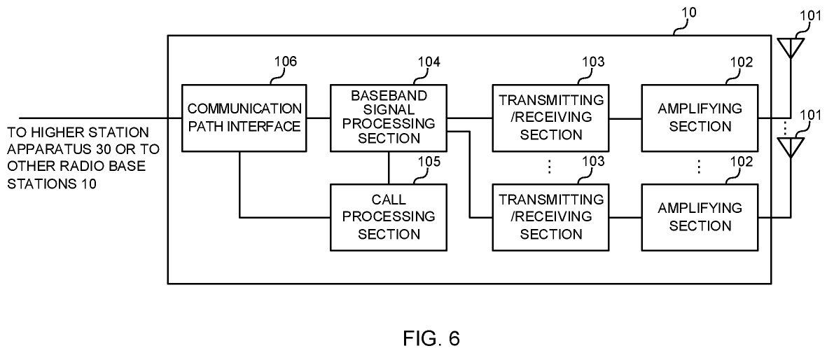

FIG. 6 is a diagram to show an exemplary overall structure of a radio base station according to the present embodiment. A radio base station 10 has a number of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process, a precoding process and so forth, and the result is forwarded to each transmitting/receiving section 103. Furthermore, downlink control signals are also subjected to transmission processes such as channel coding and an inverse fast Fourier transform, and forwarded to the transmitting/receiving sections 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

A transmitting/receiving section 103 can be constituted by a transmitters/receiver, a transmitting/receiving circuit or transmitting/receiving apparatus that can be described based on general understanding of the technical field to which this disclosure pertains. Note that a transmitting/receiving section 103 may be structured as a transmitting/receiving section in one entity, or may be constituted by a transmitting section and a receiving section.

Meanwhile, as for uplink (UL) signals, radio frequency signals that are received in the transmitting/receiving antennas 101 are each amplified in the amplifying sections 102. The transmitting/receiving sections 103 receive the UL signals amplified in the amplifying sections 102. The received signals are converted into the baseband signal through frequency conversion in the transmitting/receiving sections 103 and output to the baseband signal processing section 104.

In the baseband signal processing section 104, UL data that is included in the UL signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) with neighboring radio base stations 10 via an inter-base station interface (which is, for example, optical fiber in compliance with the CPRI (Common Public Radio Interface), the X2 interface, etc.).

Furthermore, the transmitting/receiving sections 103 transmit downlink (DL) signals (including at least one of DL data signals, DL control signals and DL reference signals) to the user terminal 20, and receive uplink (UL) signals (including at least one of UL data signals, UL control signals and UL reference signals) from the user terminal 20.

Furthermore, the transmitting/receiving sections 103 transmit DCI for the user terminal 20 by using a downlink control channel. Also, the transmitting/receiving sections 103 may transmit control information (higher layer control information) that is provided via higher layer signaling. Also, the transmitting/receiving sections 103 may transmit data (transport blocks (TBs)) to the user terminal 20 by using a downlink shared channel, and receive data (TBs) from the user terminal 20 by using an uplink shared channel.

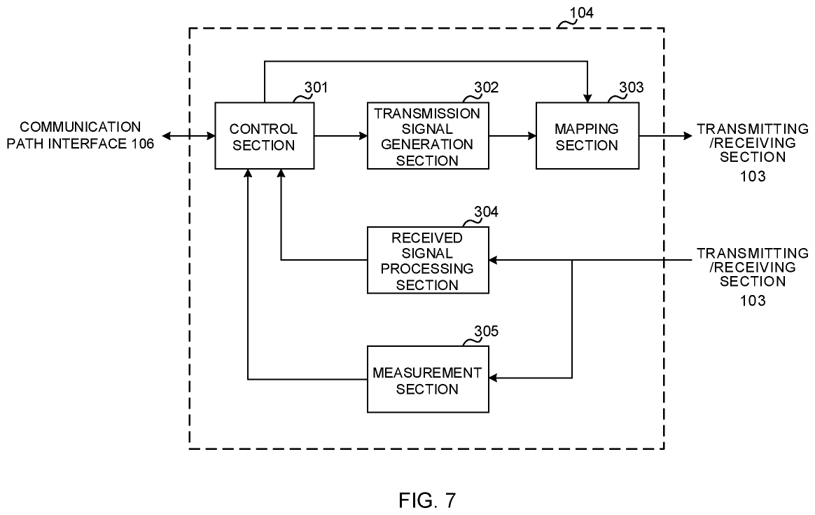

FIG. 7 is a diagram to show an exemplary functional structure of a radio base station according to the present embodiment. Note that, although FIG. 7 primarily shows functional blocks that pertain to characteristic parts of the present embodiment, the radio base station 10 has other functional blocks that are necessary for radio communication as well. The baseband signal processing section 104 has a control section 301, a transmission signal generation section 302, a mapping section 303, a received signal processing section 304 and a measurement section 305.

The control section 301 controls the whole of the radio base station 10. The control section 301 controls, for example, the generation of DL signals by the transmission signal generation section 302, the mapping of DL signals by the mapping section 303, the receiving processes (for example, demodulation) for UL signals by the received signal processing section 304 and the measurements by the measurement section 305.

To be more specific, the control section 301 schedules user terminals 20. To be more specific, the control section 301 may execute scheduling and/or retransmission control for the downlink shared channel and/or the uplink shared channel.

Also, the control section 301 may control the generation of DCI. The DCI (DL assignment) that is used to schedule the downlink shared channel may include information indicating the MCS index, the number of PRBs allocated to the downlink shared channel, and so forth. The DCI (UL grant) that is used to schedule the uplink shared channel may include information indicating the MCS index, the number of PRBs allocated to the downlink shared channel, and so forth.

Also, in a predetermined period (scheduling period corresponding to DCI), the control section 301 may exert control so that at least one of receipt and transmission of a transport block (TB) is performed using a data channel (shared channel).

Also, the control section 301 may determine the size of this TB (TBS) based on DCI. The control section 301 may determine the code rate and the modulation order corresponding to the MCS index included in DCI, with reference to, for example, the MCS table (FIG. 2A), and determine the TBS based on above steps (1) to (4).

The control section 301 may calculate the total number of resource elements allocated to the data channel in the above predetermined period (scheduling period) by taking into account other channels (for example, PDCCH, PUCCH, etc.) allocated in the predetermined period. The control section 301 may determine the above TB size (TBS) based on the total number of resource elements calculated.

The control section 301 may calculate the total number of resource elements allocated to the data channel in the above predetermined period based on the number of resource elements allocated to the above data channel in one resource block where a control channel is included, and the number of resource elements allocated to the above data channel in one resource block where no control channel is included.

The control section 301 may calculate the average number of symbols per resource block for the above data channel based on the number of symbols allocated to the above data channel in one resource block where a control channel is included, and the number of symbols allocated to the above data channel in one resource block where no control channel is included, and may calculate the total number of resource elements allocated to the data channel in the above predetermined period based on the average number of symbols.

The control section 301 can be constituted by a controller, a control circuit or control apparatus that can be described based on general understanding of the technical field to which the present invention pertains.

The transmission signal generation section 302 generates DL signals (including DL data signals, DL control signals, DL reference signals and so on) as commanded by the control section 301, and outputs these signals to the mapping section 303.

The transmission signal generation section 302 can be constituted by a signal generator, a signal generating circuit or signal generating apparatus that can be described based on general understanding of the technical field to which this disclosure pertains.

The mapping section 303 maps the DL signal generated in the transmission signal generation section 302 to a radio resource, as commanded by the control section 301, and outputs this to the transmitting/receiving sections 103. The mapping section 303 can be constituted by a mapper, a mapping circuit or mapping apparatus that can be described based on general understanding of the technical field to which this disclosure pertains.

The received signal processing section 304 performs receiving processes (for example, demapping, demodulation, decoding, etc.) of UL signals transmitted from the user terminals 20 (including, for example, a UL data signal, a UL control signal, a UL reference signal, etc.). To be more specific, the received signal processing section 304 may output the received signals, the signals after the receiving processes and so on, to the measurement section 305. In addition, the received signal processing section 304 performs UCI receiving processes based on the uplink control channel format specified by the control section 301.

The measurement section 305 conducts measurements with respect to the received signals. The measurement section 305 can be constituted by a measurer, a measurement circuit or measurement apparatus that can be described based on general understanding of the technical field to which the present invention pertains.

Also, the measurement section 305 may measure the channel quality in UL based on, for example, the received power (for example, RSRP (Reference Signal Received Power)) and/or the received quality (for example, RSRQ (Reference Signal Received Quality)) of UL reference signals. The measurement results may be output to the control section 301.

<User Terminal>

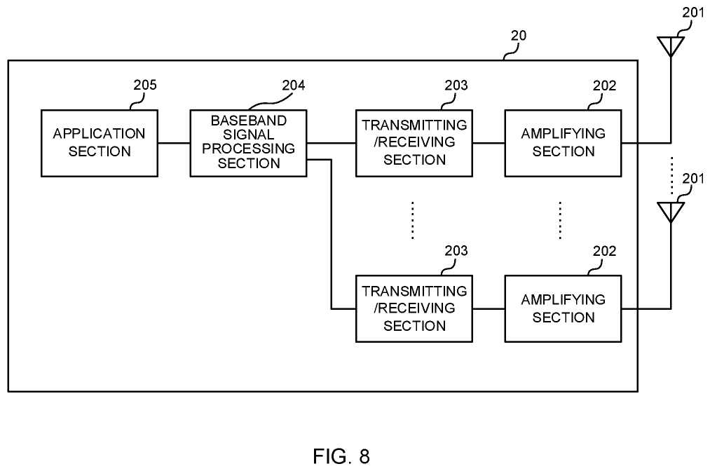

FIG. 8 is a diagram to show an exemplary overall structure of a user terminal according to the present embodiment. A user terminal 20 has a number of transmitting/receiving antennas 201 for MIMO communication, amplifying sections 202, transmitting/receiving sections 203, a baseband signal processing section 204 and an application section 205.

Radio frequency signals that are received in multiple transmitting/receiving antennas 201 are amplified in the amplifying sections 202. The transmitting/receiving sections 203 receive DL signals amplified in the amplifying sections 202. The received signals are subjected to frequency conversion and converted into the baseband signal in the transmitting/receiving sections 203, and output to the baseband signal processing section 204.

In the baseband signal processing section 204, the baseband signal that is input is subjected to an FFT process, error correction decoding, a retransmission control receiving process, and so on. The DL data is forwarded to the application section 205. The application section 205 performs processes related to higher layers above the physical layer and the MAC layer, and so on. Also, the broadcast information is also forwarded to application section 205.

Meanwhile, uplink (UL) data is input from the application section 205 to the baseband signal processing section 204. The baseband signal processing section 204 performs a retransmission control transmission process (for example, an HARQ transmission process), channel coding, rate matching, puncturing, a discrete Fourier transform (DFT) process, an IFFT process and so on, and the result is forwarded to each transmitting/receiving section 203. UCI is also subjected to at least one of channel coding, rate matching, puncturing, a DFT process and an IFFT process, and the result is forwarded to each transmitting/receiving section 203.

Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

Furthermore, the transmitting/receiving sections 203 receive downlink (DL) signals (including DL data signals, DL control signals and DL reference signals) of the numerologies configured in the user terminal 20, and transmit uplink (UL) signals (including UL data signals, UL control signals and UL reference signals) of these numerologies.

Furthermore, the transmitting/receiving sections 203 receive DCI for the user terminal 20 by using a downlink control channel. Also, the transmitting/receiving sections 203 may receive control information (higher layer control information) that is provided via higher layer signaling. Also, the transmitting/receiving sections 203 may receive data (transport blocks (TBs)) for the user terminal 20 by using a downlink shared channel, and transmit data (TBs) from the user terminal 20 by using an uplink shared channel.

A transmitting/receiving sections 203 can be constituted by a transmitter/receiver, a transmitting/receiving circuit or transmitting/receiving apparatus that can be described based on general understanding of the technical field to which this disclosure pertains. Furthermore, a transmitting/receiving sections 203 may be structured as one transmitting/receiving section, or may be formed with a transmitting section and a receiving section.

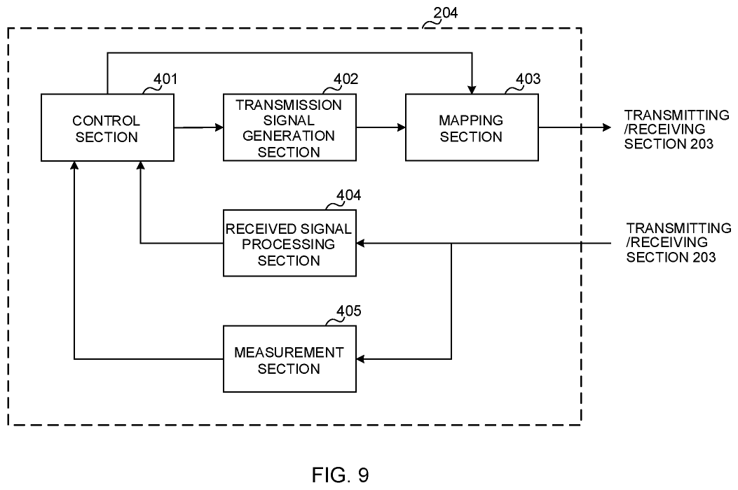

FIG. 9 is a diagram to show an exemplary functional structure of a user terminal according to the present embodiment. Note that, although FIG. 9 primarily shows functional blocks that pertain to characteristic parts of the present embodiment, the user terminal 20 has other functional blocks that are necessary for radio communication as well. The baseband signal processing section 204 provided in the user terminal 20 has a control section 401, a transmission signal generation section 402, a mapping section 403, a received signal processing section 404 and a measurement section 405.

The control section 401 controls the whole of the user terminal 20. The control section 401 controls, for example, the generation of UL signals in the transmission signal generation section 402, the mapping of UL signals in the mapping section 403, the DL signal receiving processes in the received signal processing section 404, the measurements in the measurement section 405 and so on.

Also, in a predetermined period, the control section 401 may exert control so that at least one of receipt and transmission of a transport block (TB) is performed using a data channel (shared channel). For example, based on DCI obtained from the received signal processing section 404, the control section 401 may determine the scheduling period for at least one of a TB using a downlink shared channel (PDSCH) and a TB using an uplink shared channel (PUSCH), and execute the control associated with that TB.

Also, the control section 401 may determine the size of this TB (TBS) based on DCI. The control section 401 may determine the code rate and the modulation order corresponding to the MCS index included in DCI, with reference to, for example, the MCS table (FIG. 2A), and determine the TBS based on above steps (1) to (4).

The control section 401 may calculate the total number of resource elements allocated to the data channel in the above predetermined period (scheduling period) by taking into account other channels (for example, PDCCH, PUCCH, etc.) allocated in the predetermined period. The control section 401 may determine the above TB size (TBS) based on the total number of resource elements calculated.

The control section 401 may calculate the total number of resource elements allocated to the data channel in the above predetermined period, based on the number of resource elements allocated to the above data channel in one resource block where a control channel is included, and the number of resource elements allocated to the above data channel in one resource block where no control channel is included.

The control section 401 may calculate the average number of symbols per resource block for the above data channel based on the number of symbols allocated to the above data channel in one resource block where a control channel is included, and the number of symbols allocated to the above data channel in one resource block where no control channel is included, and may calculate the total number of resource elements allocated to the data channel in the above predetermined period based on the average number of symbols.

The control section 401 can be constituted by a controller, a control circuit or control apparatus that can be described based on general understanding of the technical field to which the present invention pertains.

In the transmission signal generation section 402, UL signals (including UL data signals, UL control signals, UL reference signals, UCI, etc.) are generated (including, for example, encoding, rate matching, puncturing, modulation, etc.) as commanded by the control section 401, and output to the mapping section 403. The transmission signal generation section 402 can be constituted by a signal generator, a signal generating circuit or signal generating apparatus that can be described based on general understanding of the technical field to which this disclosure pertains.

The mapping section 403 maps the UL signals generated in the transmission signal generation section 402 to radio resources as commanded by the control section 401, and output the result to the transmitting/receiving sections 203. The mapping section 403 can be constituted by a mapper, a mapping circuit or mapping apparatus that can be described based on general understanding of the technical field to which this disclosure pertains.

The received signal processing section 404 performs receiving processes (for example, demapping, demodulation, decoding, etc.) of DL signals (including DL data signals, scheduling information, DL control signals, DL reference signals, etc.). The received signal processing section 404 outputs the information received from the radio base station 10, to the control section 401. The received signal processing section 404 outputs, for example, broadcast information, system information, high layer control information related to higher layer signaling such as RRC signaling, physical layer control information (L1/L2 control information) and so on, to the control section 401.

The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present disclosure.

The measurement section 405 measures channel states based on reference signals (for example, CSI-RS) from the radio base station 10, and outputs the measurement results to the control section 401. Note that channel state measurements may be conducted per CC.

The measurement section 405 can be constituted by a signal processor, a signal processing circuit or signal processing apparatus, and a measurer, a measurement circuit or measurement apparatus that can be described based on general understanding of the technical field to which this disclosure pertains.

<Hardware Structure>

Note that the block diagrams that have been used to describe the above embodiment show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically-separate pieces of apparatus (by using cables and/or radio, for example) and using these multiple pieces of apparatus.

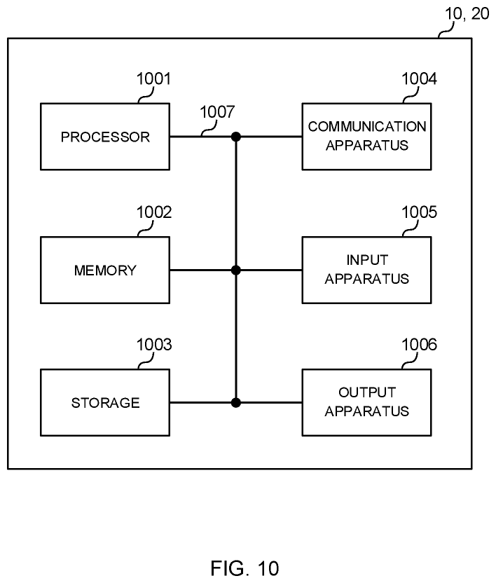

For example, the radio base stations, user terminals and so on according to one embodiment of this disclosure may function as a computer that executes the processes of the radio communication method of the present disclosure. FIG. 10 is a diagram to show an exemplary hardware structure of a radio base station and a user terminal according to the present embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. The hardware structure of a radio base station 10 and a user terminal 20 may be designed to include one or more of each apparatus shown in the drawings, or may be designed not to include part of the apparatus.

For example, although only one processor 1001 is shown, a number of processors may be provided. Furthermore, processes may be implemented with one processor, or processes may be implemented simultaneously or in sequence, or by using different techniques, on one or more processors. Note that the processor 1001 may be implemented with one or more chips.

The functions of the radio base station 10 and the user terminal 20 are implemented by, for example, allowing hardware such as the processor 1001 and the memory 1002 to read predetermined software (programs), and allowing the processor 1001 to do calculations, control communication that involves the communication apparatus 1004, control the reading and/or writing of data in the memory 1002 and the storage 1003, and so on.

The processor 1001 may control the whole computer by, for example, running an operating system. The processor 1001 may be constituted by a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so forth from the storage 1003 and/or the communication apparatus 1004, into the memory 1002, and executes various processes according to these. As for the programs, programs to allow computers to execute at least part of the operations of the above-described embodiment may be used. For example, the control section 401 of a user terminal 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory” (primary storage apparatus), and so on. The memory 1002 can store executable programs (program codes), software modules and so forth for implementing the radio communication methods according to one embodiment of this disclosure.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) or the like), a digital versatile disc, a Blu-ray (registered trademark) disk, etc.), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using cable and/or wireless networks, and may be referred to as, for example, a “network device,” a “network controller,” a “network card,” a “communication module,” and so on. The communication apparatus 1004 may be configured in include a high frequency switch, a duplexer, a filter, a frequency synthesizer and so on, in order to implement, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for allowing sending output to outside (for example, a display, a speaker, an LED (Light Emitting Diode) lamp, and so on). Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by these pieces of hardware. For example, the processor 1001 may be implemented with at least one of these pieces of hardware.

(Variations)

Note that, the terminology used in this specification and the terminology that is needed to understand this specification may be replaced by other terms that communicate the same or similar meanings. For example, a “channel” and/or a “symbol” may be replaced by a “signal” (or “signaling”). Also, a signal may be a message. A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency,” and so on.

Furthermore, a radio frame may be comprised of one or more periods (frames) in the time domain. One or more periods (frames) that constitute a radio frame may be each referred to as a “subframe.” Furthermore, a subframe may be comprised of one or more slots in the time domain. A subframe may be a fixed time duration (for example, 1 ms), which does not depend on numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a number of minislots. Each minislot may be comprised of one or more symbols in the time domain. Also, a minislot may be referred to as a “subslot.”

A radio frame, a subframe, a slot, a minislot, and a symbol all refer to a unit of time in signal communication. A radio frame, a subframe, a slot, a minislot and a symbol may be each called by other applicable names. For example, one subframe may be referred to as a “transmission time interval (TTI),” or a number of contiguous subframes may be referred to as a “TTI,” or one slot or mini-slot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent a TTI may be referred to as a “slot,” a “minislot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is not limited to this.

A TTI may be the transmission time unit of channel-encoded data packets (transport blocks), code blocks and/or codewords, or may be the unit of processing in scheduling, link adaptation, and so on. Note that, when a TTI is given, the period of time (for example, the number of symbols) in which transport blocks, code blocks and/or codewords are actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit for scheduling may be controlled.

A TTI having a time length of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI” (or a “fractional TTI”), a “shortened subframe,” a “short subframe,” a “minislot,” a “sub-slot,” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a number of contiguous subcarriers in the frequency domain. Also, an RB may include one or more symbols in the time domain, and may be one slot, one minislot, one subframe or one TTI in length. One TTI and one subframe each may be comprised of one or more resource blocks. Note that one or more RBs may be referred to as a “physical resource block (PRB (Physical RB)),” a “subcarrier group (SCG),” a “resource element group (REG),” a “PRB pair,” an “RB pair,” and so on.

Furthermore, a resource block may be comprised of one or more resource elements (REs). For example, one RE may be a radio resource field of one subcarrier and one symbol.

Note that the structures of radio frames, subframes, slots, minislots, symbols, and so on described above are simply examples. For example, configurations pertaining to the number of subframes included in a radio frame, the number of slots included in a subframe or a radio frame, the number of minislots included in a slot, the number of symbols and RBs included in a slot or a minislot, the number of subcarriers included in an RB, the number of symbols in a TTI, the symbol duration, the length of cyclic prefixes (CPs), and so on can be variously changed.

Also, the information and parameters described in this specification may be represented in absolute values or in relative values with respect to predetermined values, or may be represented using other applicable information. For example, a radio resource may be indicated by a predetermined index.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a number of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

The method of reporting information is by no means limited to those used in the examples/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling, etc.), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, or by reporting another piece of information).

Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode,” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, instructions, information and so on may be transmitted and received via communication media. For example, when software is transmitted from a website, a server or other remote sources by using wired technologies (coaxial cables, optical fiber cables, twisted-pair cables, digital subscriber lines (DSL) and so on), and/or wireless technologies (infrared radiation, microwaves, and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” a “NodeB,” an “eNodeB (eNB),” an “access point,” a “transmission point,” a “receiving point,” a “transmitting/receiving point,” a “femto cell,” a “small cell,” and so on.

A base station can accommodate one or more (for example, three) cells (also referred to as “sectors”). When a base station accommodates a number of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS),” “user terminal,” “user equipment (UE),” and “terminal” may be used interchangeably.

A mobile station may be referred to as a “subscriber station,” a “mobile unit,” a “subscriber unit,” a “wireless unit,” a “remote unit,” a “mobile device,” a “wireless device,” a “wireless communication device,” a “remote device,” a “mobile subscriber station,” a “access terminal,” a “mobile terminal,” a “wireless terminal,” a “remote terminal,” a “handset,” a “user agent,” a “mobile client,” a “client,” or some other suitable terms.

A base station and/or a mobile station may be referred to as “transmitting apparatus,” “receiving apparatus,” and the like.

Furthermore, the radio base stations in this specification may be interpreted as user terminals. For example, each example/embodiment of this disclosure may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, MMEs (Mobility Management Entities), S-GWs (Serving-Gateways), and so on may be possible, but these are by no means limiting) other than base stations, or combinations of these.

The examples/embodiments illustrated in this specification may be used individually or in combinations, which may be switched depending on the mode of implementation. Also, the order of processes, sequences, flowcharts, and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), other adequate radio communication methods, and/or next-generation systems that are enhanced based on these.

The phrase “based on” as used in this specification does not mean “based only on” unless otherwise specified. In other words, the phrase “based on” means both “based only on” and “based at least on.”

Reference to elements with designations such as “first,” “second,” and so on as used herein does not generally limit the number/quantity or order of these elements. These designations are used herein only for convenience, as a method for distinguishing between two or more elements. It follows that reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database, or some other data structure), ascertaining, and so on. Furthermore, to “judge” and “determine” as used in the present disclosure may be interpreted as meaning making judgements and determinations related to receiving (for example, receiving information), transmitting (for example, transmitting information), inputting, outputting, accessing (for example, accessing data in a memory) and so on. In addition, to “judge” and “determine” as used in the present disclosure may be interpreted as meaning making judgements and determinations related to resolving, selecting, choosing, establishing, comparing, and so on. In other words, to “judge” and “determine” as used in the present disclosure may be interpreted as meaning making judgements and determinations with regard to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used herein, when two elements are connected, these elements may be considered “connected” or “coupled” to each other by using one or more electrical wires, cables, and/or printed electrical connections, and, as a number of non-limiting and non-inclusive examples, by using electromagnetic energy having wavelengths of the radio frequency region, the microwave region and/or the optical region (both visible and invisible).

In the present specification, the phrase “A and B are different” may mean “A and B are different from each other.” The terms such as “leave,” “coupled” and the like may be interpreted likewise.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

(Supplementary Notes)

Now, supplementary notes of the present disclosure will follow below:

<Background>

According to the current specifications of NR (New Radio Technology), the TBS is calculated from the number of resource elements (REs) (the number of REs) allocated to a downlink shared channel (PDSCH (Physical Downlink Shared CHannel)) in one PRB.

This is to maintain the desired target code rate.

N′_{RE}=N_{sc}^{RB}*N^{sh}_{symb}−N_{DMRS}^{PRB}−Nₒₕ^{PRB}

→Quantization from N′_{RE} toN̅′̅_{RE}→N_{RE}=N̅′̅_{RE}*n_{PRB}

The above equation assumes that no downlink control channel is included, and that the PDSCH (PDCCH (Physical Downlink Control CHannel)) is allocated such that each resource block (RB) includes the same OFDM (Orthogonal Frequency-Division Multiplexing) symbols.

However, the PDCCH may be allocated in part of the resource blocks allocated to the PDSCH. Therefore, the above equation cannot calculate the correct number of REs.

<Proposal>

It is proposed to calculate the correct number of REs by taking into account the PDCCH. Better throughput performance can be achieved for desired target code rates.

### Example 1

»N′_{RE1}=N_{sc}^{RB}*N^{sh}_{symb1}−N_{DMRS}^{PRB}−Nₒₕ^{PRB} for RBs including PDCCH

»N′_{RE2}=N_{sc}^{RB}*N^{sh}_{symb2}−N_{DMRS}^{PRB}−Nₒₕ^{PRB} for RBs not including PDCCH

»Quantization from N′_{RE1} to N̅′̅_{RE1} and quantization from N′_{RE2} to N̅′̅_{RE2}

»→N_{RE}=N̅′_{RE1}*n_{PRB1}+N̅′_{RE2}*n_{PRB2}

### Example 2

»N′_{RE}=N_{sc}^{RB}*N̅^{sh}_{symb}−N_{DMRS}^{PRB}−Nₒₕ^{PRB}→Quantization from N′_{RE} to N̅′̅_{RE}→N_{RE}=N̅′̅_{RE}*n_{PRB}−N̅^{sh}_{symb}=(N^{sh}_{symb1}*n_{PRB1}+N^{sh}_{symb2}*n_{PRB2})/(n_{PRB1}+n_{PRB2})

### Example 3

»Nₒₕ^{PRB} takes PDCCH into account.

Any other parameters may be introduced, or changes may be made.

For example, the equation in example 2 may be modified as follows.

N′_{RE}=N_{sc}^{RB}*N̅^{sh}_{symb}−N_{DMRS}^{PRB}−Nₒₕ^{PRB}−N_{UCI}^{PRB}

In view of the above, the following configurations are proposed.

### [Configuration 1]

A user terminal including

a transmitting/receiving section that performs at least one of receipt and transmission of a transport block (TB) by using a data channel in a predetermined period, and

a control section that calculates a total number of resource elements allocated to the data channel in the predetermined period, by taking into account another channel that is allocated in the predetermined period.

### [Configuration 2]

The user terminal according to configuration 1, in which the control section calculates a total number of resource elements allocated to the data channel in the predetermined period, based on the number of resource elements allocated to the data channel in one resource block, in which a control channel is included, and the number of resource elements allocated to the data channel in one resource block, in which the control channel is not included.

### [Configuration 3]

The user terminal according to configuration 1, in which the control section calculates an average number of symbols per resource block for the data channel, based on the number of symbols allocated to the data channel in one resource block, in which a control channel is included, and the number of symbols allocated to the data channel in one resource block, in which the control channel is not included, and calculates a total number of resource elements allocated to the data channel in the predetermined period, based on the average number of symbols.

### [Configuration 4]

A radio communication method including, in a user terminal, the steps of

performing at least one of receipt and transmission of a transport block (TB) by using a data channel in a predetermined period, and

calculating a total number of resource elements allocated to the data channel in the above predetermined period, by taking into account another channel that is allocated in the predetermined period.

Now, although the invention according to the present disclosure has been described in detail above, it should be obvious to a person skilled in the art that the invention according to the present disclosure is by no means limited to the embodiments described herein. The present disclosure can be implemented with various corrections and in various modifications, without departing from the spirit and scope of the present invention defined based on the recitations of claims. Consequently, the description herein is provided only for the purpose of explaining examples, and should by no means be construed to limit the invention concerning this disclosure in any way.

The disclosure of Japanese Patent Application No. 2018-051666, filed on Mar. 1, 2018, including the specification, drawings and abstract, is incorporated herein by reference in its entirety.

1. A user terminal comprising:
a transmitting/receiving section that performs at least one of receipt and transmission of a transport block (TB) by using a data channel in a predetermined period; and
a control section that calculates a total number of resource elements allocated to the data channel in the above predetermined period, by taking into account another channel that is allocated in the predetermined period.

2. The user terminal according to claim 1, wherein the control section calculates a total number of resource elements allocated to the data channel in the predetermined period, based on the number of resource elements allocated to the data channel in one resource block, in which a control channel is included, and the number of resource elements allocated to the data channel in one resource block, in which the control channel is not included.

3. The user terminal according to claim 1, wherein the control section calculates an average number of symbols per resource block for the data channel, based on the number of symbols allocated to the data channel in one resource block, in which a control channel is included, and the number of symbols allocated to the data channel in one resource block, in which the control channel is not included, and calculates a total number of resource elements allocated to the data channel in the predetermined period, based on the average number of symbols.

4. A radio communication method comprising, in a user terminal, the steps of:
performing at least one of receipt and transmission of a transport block (TB) by using a data channel in a predetermined period; and
calculating a total number of resource elements allocated to the data channel in the above predetermined period, by taking into account another channel that is allocated in the predetermined period.
